(19) United States
(12) Patent Application Publication
(10) Pub. No.: US 2015/0224733 A1
(43) Pub. Date: Aug. 13, 2015

(54) CORRUGATED CARDBOARD INSTALLATION

(71) Applicant: BHS Corrugated Maschinen-und Anlagenbau GmbH, Weiherhammer (DE)

(72) Inventors: Martin HÄGLER, Luhe-Wildenau (DE); Helmut KRAUS, Wackersdorf (DE)

(21) Appl. No.: 14/619,452

(22) Filed: Feb. 11, 2015

(30) Foreign Application Priority Data
Feb. 12, 2014 (DE) 10 2014 202 537.0

(51) Int. Cl. B31F 1/20; B32B 37/16; B32B 37/12; B32B 37/00; B32B 37/02; B32B 38/00; B32B 41/00; B31F 5/04; B32B 37/06

(52) U.S. Cl. CPC B31F 1/20; B31F 5/04; B32B 37/16; B32B 37/1284; B32B 37/06; B32B 37/02; B32B 38/0012; B32B 38/0004; B32B 41/00; B32B 37/0046; B31F 2201/00

(57) ABSTRACT

The invention relates to a corrugated cardboard installation. The corrugated cardboard installation comprises a first material supply device for dispensing a first material web, a second material supply device for dispensing a second material web, a first corrugated cardboard production assembly for producing a first corrugated cardboard web from the first material web and the second material web, a cross-cutting assembly for producing corrugated cardboard sheets from the first corrugated cardboard web, a warp detection assembly for detecting the warp of corrugated cardboard sheets or partial corrugated cardboard webs, an information processing device receiving warp information from the warp detection assembly relating to the corrugated cardboard sheets or the partial corrugated cardboard webs, and at least one corrugated cardboard sheet warp influencing assembly (actuable depending on signals received from the information processing device for influencing the warp of the corrugated cardboard sheets.

### CROSS-REFERENCES TO RELATED APPLICATIONS

This application claims the priority of German Patent Application, Serial No. 10 2014 202 537.0, filed Feb. 12, 2014, pursuant to 35 U.S.C. 119(a)-(d), the content of which is incorporated herein by reference in its entirety as if fully set forth herein.

### FIELD OF THE INVENTION

The invention relates to a corrugated cardboard installation for the production of corrugated cardboard sheets. The invention further relates to a method for the production of corrugated cardboard sheets in a corrugated cardboard installation.

### BACKGROUND OF THE INVENTION

Corrugated cardboard installations for the production of corrugated cardboard sheets are generally known from prior art through prior public use. The corrugated cardboard sheets are produced from endless corrugated cardboard webs or from partial corrugated cardboard webs which are in turn produced from the endless corrugated cardboard webs. A common problem in the production of corrugated cardboard webs is that the corrugated cardboard webs are warped or curved after production thereof. This is generally due to an incorrect setting of the corrugated cardboard installation, defects in the corrugated cardboard installation and/or a poor quality of the raw materials used, such as the raw paper. Corrugated cardboard sheets warped in this manner are often unsuitable for further use.

### SUMMARY OF THE INVENTION

An object of the invention is therefore to provide a corrugated cardboard installation for the production of corrugated cardboard sheets which is able to overcome the drawbacks set out above. In particular, the object of the invention is to provide a corrugated cardboard installation for the production of corrugated cardboard sheets that have a desired warp or plane shape while further allowing deviations from said desired warp or said desired plane shape of the corrugated cardboard sheets to be detected as early as possible in the production of said corrugated cardboard sheets. Another object of the invention is to provide a corresponding method for producing corrugated cardboard sheets.

According to the invention, this object is achieved by a corrugated cardboard installation for the production of corrugated cardboard sheets, comprising a first material supply device for dispensing a first material web, a second material supply device for dispensing a second material web, a first corrugated cardboard production device for producing a first corrugated cardboard web laminated on at least one side from at least the first material web and the second material web, a cross-cutting assembly for producing corrugated cardboard sheets from at least the first corrugated cardboard web laminated on at least one side, a warp detection assembly for detecting a warp of the corrugated cardboard sheets and/or of partial corrugated cardboard webs produced at least from the first corrugated cardboard web laminated on at least one side, an information processing device which receives from the warp detection assembly warp information relating to the corrugated cardboard sheets and/or the partial corrugated cardboard webs, and at least one corrugated cardboard sheet warp influencing assembly for influencing the warp of the corrugated cardboard sheets, wherein the at least one corrugated cardboard sheet warp influencing assembly is actuable depending on the signals received from the information processing device, and by a method for the production of corrugated cardboard sheets, comprising the steps of dispensing a first material web from a first material supply device, dispensing a second material web from a second material supply device, producing, by means of a first corrugated cardboard production assembly, a first corrugated cardboard web laminated on at least one side from at least the first material web and the second material web, producing corrugated cardboard sheets from at least the first corrugated cardboard web laminated on at least one side by means of a cross-cutting assembly, detecting a warp of the corrugated cardboard sheets and/or of partial corrugated cardboard webs from at least the first corrugated cardboard web laminated on at least one side by means of a warp detection assembly, transmitting warp information relating to the corrugated cardboard sheets and/or the partial corrugated cardboard webs from the warp detection assembly to an information processing device, and influencing the warp of the corrugated cardboard sheets depending on signals received from the information processing device by means of at least one actuable corrugated cardboard sheet warp influencing assembly. The gist of the invention is that a warp detection device detects a warp of the corrugated cardboard sheets and/or partial corrugated cardboard webs. The warp of the corrugated cardboard sheets is influenceable, in particular regulable, by means of at least one corrugated cardboard sheet warp influencing assembly in such a way that the corrugated cardboard sheets have a desired warp or follow a desired path along their length and/or width as defined by warp information relating to the corrugated cardboard sheets and/or partial corrugated cardboard webs.

The first material supply device is preferably configured as a splicer.

It is advantageous if the second material supply device is configured as a splicer as well.

The cross-cutting device advantageously comprises at least one knife roller with at least one knife for cross-cutting at least the first corrugated cardboard web laminated on at least one side.

Preferably, an endless corrugated cardboard web, which is or comprises the first corrugated cardboard web, is cut and divided into a number of partial corrugated cardboard webs. It is advantageous if each partial corrugated cardboard web is associated to at least one knife roller with at least one knife for cross-cutting the respective corrugated cardboard web. It is advantageous if a longitudinal cutting and corrugating assembly is provided to produce the partial corrugated cardboard webs from at least the first and second material webs.

The warp detection device is in particular able to detect whether the corrugated cardboard sheets and/or the partial corrugated cardboard webs are at least partially warped or non-warped along the length and/or width thereof.

Advantageously, the warp detection device is contactless. The warp detection device detects for instance the respective distance from the respective corrugated cardboard sheet or from the respective partial corrugated cardboard web across the entire width and/or length thereof. Alternatively, the warp detection device preferably detects the profile of the entire respective corrugated cardboard sheet or of the entire respective partial corrugated cardboard web. In a particularly preferred embodiment, the warp detection device is configured as a laser distance detection device or as a line profile detection device.

It is expedient if the warp detection device is immovable at least in a transport direction of the web or corrugated cardboard sheets.

It is advantageous if the information processing device is an electronic information processing device.

Preferably, several corrugated cardboard sheet warp influencing assemblies are provided. It is advantageous if the information processing device sends actuating signals to at least one of the corrugated cardboard sheet warp influencing assemblies to influence the warp of the corrugated cardboard sheets.

When it is necessary to influence the warp of the corrugated cardboard sheets, it is advantageous if at least one, preferably more than one, more preferably all of the corrugated cardboard sheet warp influencing assemblies influence the warp of the corrugated cardboard sheets in and/or transverse to the transport direction thereof.

The warp of the corrugated cardboard sheets is influenceable for instance by changing the moisture and/or temperature on one side of at least one material web or at least one corrugated cardboard web.

It is expedient if a wireless or wired signal communication is provided between the information processing device and the at least one corrugated cardboard sheet warp influencing assembly.

Advantageously, a wireless or wired signal communication is provided between the warp detection device and the information processing device.

It is advantageous if the first preheating assembly, which serves as a first corrugated cardboard sheet warp influencing assembly for influencing the warp of the corrugated cardboard sheets by preheating the first material web on one side, is arranged between the first material supply device and the first corrugated cardboard production assembly, said first corrugated cardboard sheet warp influencing assembly being associated to the first material web, and comprises a first preheating roller which is partly in contact with the first material web. The first material web is thus preheated at least partly across the thickness thereof from the side which is in contact with the first preheating roller. The preheating temperature of the first preheating roller is changeable by means of the information processing device, which results in a changed warp of the corrugated cardboard sheets. When said preheating temperature is increased, this causes the corrugated cardboard sheets to warp downwardly, thus resulting in a so-called down-warp.

The second corrugated cardboard sheet warp influencing assembly of the first corrugated cardboard production assembly is configured as a glue application assembly for applying glue to one side of the first material web and/or the second material web, wherein allows the layer of glue applied to the first and/or second material web to be changed by means of the information processing device which changes an application of glue to the first material web and/or the second material web by means of the glue application assembly in order to influence the warp of the corrugated cardboard sheets, which results in a changed warp of the corrugated cardboard sheets. In particular, the amount of glue applied thereto is changeable. Alternatively, the composition, in particular the moisture, of the glue is changeable. It is advantageous if the glue application device comprises a glue application roller which applies glue to the side of the respective material web abutting against said glue application roller. By changing the position of the glue application roller relative to said material web, it is for instance possible to easily change the amount of glue applied to said material web, which in turn influences the moisture of said material web. When the moisture in the second material web is increased, this causes the corrugated cardboard sheets to be warped upwardly, thus resulting in a so-called up-warp.

The third material supply device set out for dispensing a third material web is preferably configured as a splicer.

It is advantageous if the fourth material supply device is configured as a splicer.

It is conceivable for the first corrugated cardboard web and the second corrugated cardboard web to be joined, more preferably glued, to each other preferably in the manner of layers. Preferably, another cover layer can be joined, more preferably glued, to a free corrugated web of the first or second corrugated cardboard web.

It is advantageous if a third corrugated cardboard sheet warp influencing assembly, configured as a second preheating assembly for influencing the warp of the corrugated cardboard sheets by preheating the third material web on one side, is arranged between the third material supply device and the second corrugated cardboard production assembly, said third corrugated cardboard sheet warp influencing assembly comprising a second preheating roller which is partly in contact with the third material web. The third material web is thus preheated at least partly across the thickness thereof from the side which is in contact with the second preheating roller. The preheating temperature of the second preheating roller is changeable by means of the information processing device, which results in a changed warp of the corrugated cardboard sheets. When said preheating temperature is increased, this causes the corrugated cardboard sheets to warp downwardly, thus resulting in a so-called down-warp.

The fourth corrugated cardboard sheet warp influencing assembly is configured as a glue application assembly of the second corrugated cardboard production assembly for applying glue to one side of the third material web and/or the fourth material web, thus allowing the layer of glue applied to the third and/or fourth material web to be changed by means of the information processing device which changes an application of glue to the third material web and/or the fourth material web by means of the glue application assembly, thus resulting in a changed warp of the corrugated cardboard sheets. In particular, the amount of glue applied thereto is changeable. Alternatively, the composition, in particular the moisture, of the glue is changeable. It is advantageous if the glue application assembly comprises a glue application roller which applies glue to the side of the respective material web abutting against said glue application roller. By changing the position of the glue application roller relative to said material web, it is for instance possible to easily change the amount of glue applied to said material web, which in turn influences the moisture of said material web. When the moisture in the fourth material web is increased, this causes the corrugated cardboard sheets to be warped upwardly, thus resulting in a so-called up-warp.

Preferably, the fifth corrugated cardboard sheet warp influencing assembly configured as a preheating assembly for preheating a respective side of at least the first corrugated cardboard web and the second corrugated cardboard web from in each case one side in order to influence the warp of the corrugated cardboard sheets has a preheating roller associated to the first corrugated cardboard web, wherein the first corrugated cardboard web partly abuts against the outside thereof so as to be preheated from its side abutting against said preheating roller.

Advantageously, the preheating assembly has another preheating roller associated to the second corrugated cardboard web, wherein the second corrugated cardboard web partly abuts against the outside thereof so as to be preheated from its side abutting against said preheating roller.

It is expedient if the preheating assembly comprises another preheating roller associated to a cover layer, wherein said cover layer partly abuts against the outside thereof so as to be preheated from its side abutting against said preheating roller.

The preheating temperature of the preheating assembly is changeable for the first corrugated cardboard web, the second corrugated cardboard web and/or the cover layer, which results in a changed warp of the corrugated cardboard sheets. Preferably, the preheating temperature of at least one, more preferably of all preheating rollers of the preheating assembly is changeable, which results in a changed warp of the corrugated cardboard sheets. When the preheating temperature for the first corrugated cardboard web is increased, this causes the corrugated cardboard sheets to be warped downwardly, thus resulting in a down-warp. When the preheating temperature for the cover layer is increased, this causes the corrugated cardboard sheets to be warped upwardly, thus resulting in an up-warp.

Preferably, the sixth corrugated cardboard sheet warp influencing assembly, configured as a glue application assembly for applying glue to a respective side of the first corrugated cardboard web and the second corrugated cardboard web in order to influence the warp of the corrugated cardboard sheets, has a first glue application device associated to the first corrugated cardboard web, allowing glue to be applied to said first corrugated cardboard web.

Advantageously, the glue application assembly has a second glue application device associated to the second corrugated cardboard web, allowing glue to be applied to said second corrugated cardboard web.

The layer of glue applied to the first and/or second material web is changeable, thus causing the warp of the corrugated cardboard sheets to change. In particular, the amount of glue applied thereto is changeable. Alternatively, the composition, in particular the moisture, of the glue is changeable. It is advantageous if the first glue application device comprises a first glue application roller which applies glue to the side of the respective material web abutting against said glue application roller. Advantageously, the second glue application device has a second glue application roller which applies glue to the side of the respective material web abutting against said glue application roller. By changing the position of the first and/or second glue application roller relative to the associated corrugated cardboard web, it is for instance possible to easily change the amount of glue applied to said corrugated cardboard web, which in turn influences the moisture in said material web. When the moisture in the first corrugated cardboard web is increased, this causes the corrugated cardboard sheets to be warped upwardly, thus resulting in a so-called up-warp. When the moisture in the second corrugated cardboard web is increased, this causes the corrugated cardboard sheets to be warped downwardly, thus resulting in a so-called down-warp.

It is advantageous if the seventh corrugated cardboard sheet warp influencing assembly, configured as a heating and pressing assembly for pressing together the first corrugated cardboard web, the second corrugated cardboard web and a cover web, and for heating at least one of them on one side in order to influence the warp of the corrugated cardboard sheets cardboard sheets, comprises at least one heating member the heating temperature of which is changeable by means of the information processing device. The at least one heating member allows the entire corrugated cardboard web to be heated. When the heating temperature of the at least one heating member is changed, this causes the warp of the corrugated cardboard sheets to change. The at least one heating member is arranged adjacent to the outer corrugated cardboard web and/or the cover layer. Preferably, it is only adjacent to the cover layer. When the heating temperature for the cover layer is changed, this causes the corrugated cardboard sheets to be warped upwardly, thus resulting in an up-warp.

Preferably, the heating and pressing assembly has at least one pressure member which is in particular configured as a rotating pressure belt that is preferably in a pressing engagement with the first corrugated cardboard web. The at least one pressing member preferably allows the moisture in the first corrugated cardboard web to be changed alternatively or in addition to the heating temperature change performed by the at least one heating member, thus allowing the warp of the corrugated cardboard sheets to be influenced as well. When the moisture in the first corrugated cardboard web is increased by means of the first pressure member, this causes the corrugated cardboard sheets to be warped upwardly, thus resulting in an up-warp. It is advantageous if the at least one pressure member allows steam or liquid to be applied to the first corrugated cardboard web, preferably by spraying. It is expedient if at least one, more preferably a plurality of outlet openings are formed in the at least one pressure member, said outlet openings allowing said liquid or steam to be transported to the first corrugated cardboard web.

As a general rule, it shall be noted that when the corrugated cardboard sheet warp influencing assemblies are operated inversely to the mode of operation set out above, in other words the preheating temperature or the moisture in the web is reduced, this results in a corresponding inverse warp of the corrugated cardboard sheets.

The degree of actuation of the corrugated cardboard sheet warp influencing assemblies allows one to influence the degree of the warp of the corrugated cardboard sheets.

When several corrugated cardboard sheet warp influencing assemblies having the same influence on the warp behaviour of the corrugated cardboard sheets are operated at the same time, this allows the corrugated cardboard sheets to be warped to a greater degree.

When the corrugated cardboard sheets are warped downwardly, in other words in the case of a down-warp, the edges of the corrugated cardboard sheets running transversely to the transport direction of the corrugated cardboard web, said edges thus being leading or trailing, are each arranged substantially such as to face downwardly, in other words they are arranged below a central region of the respective corrugated cardboard sheet running parallel to and between said edges.

When the corrugated cardboard sheets are warped upwardly, in other words in the case of an up-warp, the edges of the corrugated cardboard sheets running transversely to the transport direction of the corrugated cardboard web, said edges thus being leading or trailing, are each arranged substantially such as to face upwardly, in other words they are arranged above a central region of the respective corrugated cardboard sheet running parallel to and between said edges.

The first warp detection device arranged upstream of the cross-cutting assembly, preferably between the cross-cutting assembly and a longitudinal cutting and corrugating assembly for producing the partial corrugated cardboard webs, said longitudinal cutting and corrugating assembly being arranged upstream of the cross-cutting assembly may be different from or identical to the second warp detection device arranged downstream of the cross-cutting assembly for detecting the warp of the corrugated cardboard sheets. Preferably, each of them is in signal communication with the information processing device. It is expedient if the information processing device receives information from the first warp detection device relating to the partial corrugated cardboard webs. It is expedient if the information processing device receives information from the second warp detection device relating to the corrugated cardboard sheets.

The embodiment in which the information processing device interrupts a regulation of the warp of the corrugated cardboard sheets when the warp of the partial corrugated cardboard webs is changed at the first warp detection device by means of at least one of the corrugated cardboard sheet warp influencing assemblies, and the information processing device then compares at the second warp detection device the actual warp of the corrugated cardboard sheets with the desired warp of the corrugated cardboard sheets, wherein the information processing device continues to do so until the actual warp of the corrugated cardboard sheets corresponds to the desired warp of the corrugated cardboard sheets, results in an extremely high quality of the corrugated cardboard sheets.

The embodiment in which the information processing device immediately initiates a change of the warp of the corrugated cardboard sheets by means of at least one of the corrugated cardboard sheet warp influencing assemblies as soon as a change in the warp of the partial corrugated cardboard webs is detected at the first warp detection device, wherein preferably the information processing device stores the warp tendency from the first warp detection device towards the second warp detection device to reduce the regulation path to the first warp detection device, results in an extremely fast reaction time, thus allowing the number of corrugated cardboard sheets of poor quality to be reduced to a minimum.

The embodiments set out above may also be preferred further developments of the method for the production of corrugated cardboard sheets.

In the following sections, a preferred embodiment of the invention will be described by way of example with reference to the attached drawing.

### BRIEF DESCRIPTION OF THE DRAWING

FIG. 1 shows a first part of a corrugated cardboard installation according to the invention, and

FIG. 2 shows a second part of the corrugated cardboard installation according to the invention shown in FIG. 1.

### DESCRIPTION OF THE PREFERRED EMBODIMENT

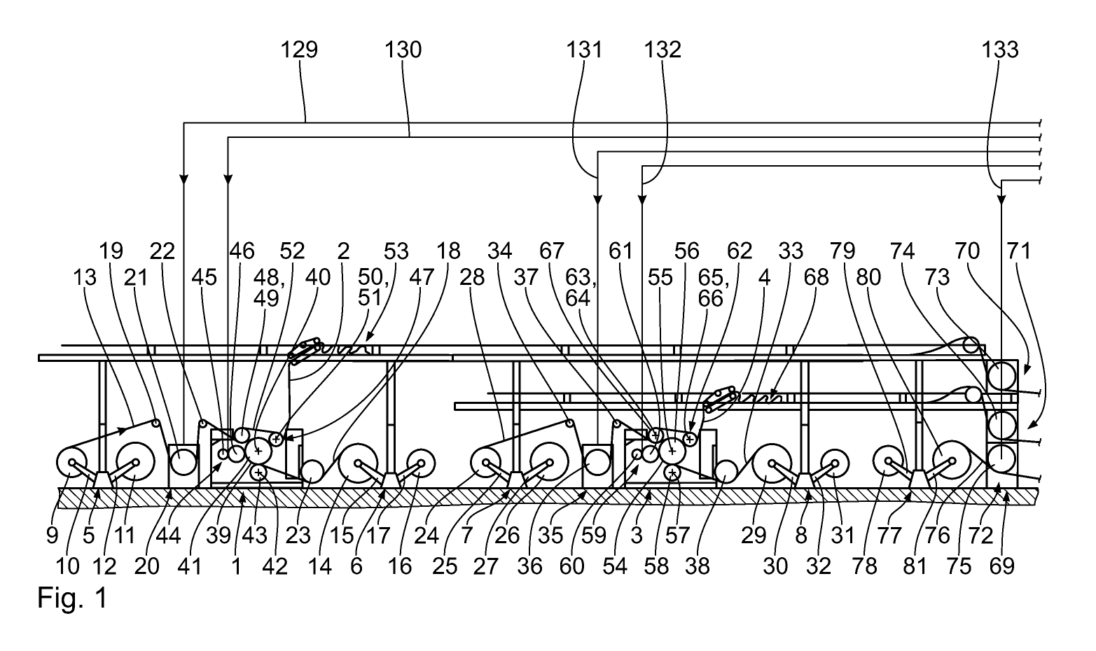

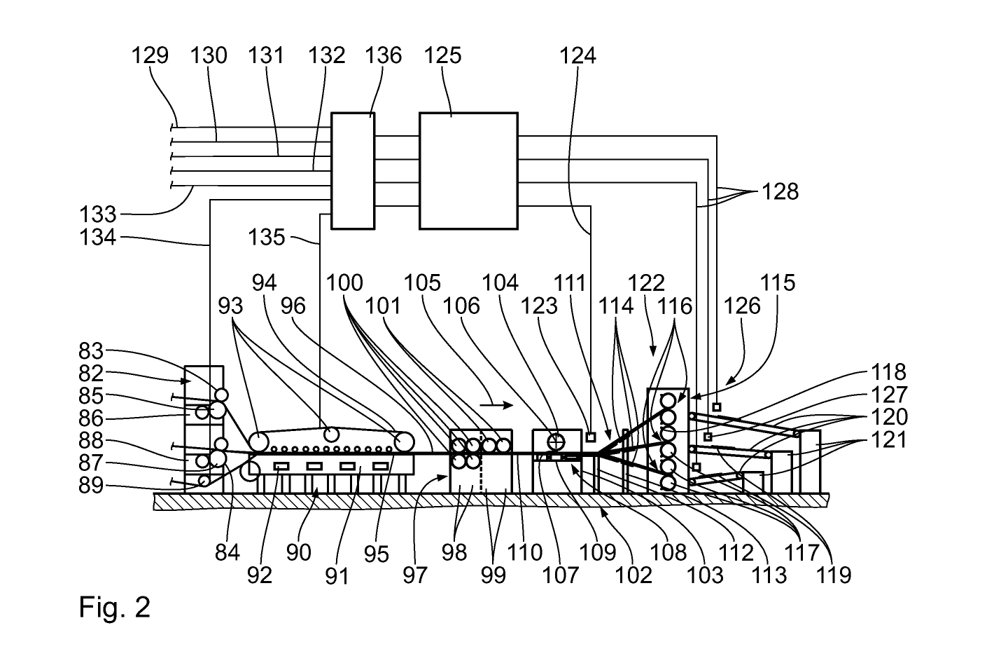

A corrugated cardboard installation as shown in the schematic view according to FIGS. 1 and 2 comprises a first corrugated cardboard production assembly 1 for the production of an endless first single-face laminated corrugated cardboard web 2 and a second corrugated cardboard production assembly 3 for the production of an endless first single-face laminated corrugated cardboard web 4.

The first corrugated cardboard production assembly 1 is associated to a first splicer 5 and a second splicer 6 while the second corrugated cardboard production assembly 3 is associated to a third splicer 7 and a fourth splicer 8.

In order to unwind a non-endless first material web from a first material web roll 9, the first splicer 5 comprises a first unwinding unit 10 and a second unwinding unit 12 in order to unwind a non-endless second material web from a second material web roll 11. The non-endless first and second material webs are joined together by means of a joining and cutting unit (not shown) of the first splicer 5 in order to provide an endless first material web 13. Each time a non-endless first material web is joined to a non-endless second material web, a first joint (not shown) is produced in the endless first material web 13.

The second splicer 6 corresponds to the first splicer 5. Said second splicer 6 has a third unwinding unit 15 in order to unwind a non-endless third material web from a third material web roll 14, and a fourth unwinding unit 17 in order to unwind a non-endless fourth material web from a fourth material web roll 16. The non-endless third and fourth material webs are joined together by means of a joining and cutting unit (not shown) of the second splicer 6 in order to produce an endless second material web 18. Each time a third material web is joined to a fourth material web, a second joint (not shown) is produced in the endless second material web 18.

Via at least one first deflection roller 19, the endless first material web 13 is preferably supplied to a first preheating assembly 20 which comprises a first heatable preheating roller 21. One side of the endless first material web 13 partly abuts against the outside of the first preheating roller 21. The endless first material web 13 thus preheated is then preferably supplied to the first corrugated cardboard production assembly 1 via at least one second deflection roller 22.

The endless second material web 18 is preferably supplied to the first corrugated cardboard production assembly 1 via at least one third deflection roller 23.

The third splicer 7 corresponds to the first splicer 5. Said third splicer 7 has a fifth unwinding unit 25 in order to unwind a non-endless fifth material web from a fifth material web roll 24, and a sixth unwinding unit 27 in order to unwind a non-endless sixth material web from a sixth material web roll 26. The non-endless fifth and sixth material webs are joined together by means of a joining and cutting unit (not shown) of the third splicer 7 in order to produce an endless third material web 28. Each time a fifth material web is joined to a sixth material web, a third joint (not shown) is produced in the endless third material web 28.

The fourth splicer 8 substantially corresponds to the second splicer 6. Said fourth splicer 8 has a seventh unwinding unit 30 in order to unwind a non-endless seventh material web from a seventh material web roll 29, and an eighth unwinding unit 32 in order to unwind a non-endless eighth material web from an eighth material web roll 31. The non-endless seventh and eighth material webs are joined together by means of a joining and cutting unit (not shown) of the fourth splicer 8 in order to produce an endless fourth material web 33. Each time a seventh material web is joined to an eighth material web, a fourth joint (not shown) is produced in the endless fourth material web 33.

Via at least one fourth deflection roller 34, the endless third material web 28 is preferably supplied to a second preheating assembly 35 which comprises a second heatable preheating roller 36. One side of the endless third material web 28 partly abuts against the outside of the second preheating roller 36 so as to be heated from this side. The endless third material web 28 thus preheated is then preferably supplied to the second corrugated cardboard production assembly 3 via at least one fifth deflection roller 37.

The temperatures of the first preheating assembly 20 and the second preheating assembly 35 are changeable independently of each other, in other words the first and second preheating assemblies 20, 35 are heatable independently of each other. The preheating temperatures of the preheating rollers 21, 36 thereof are changeable.

The endless fourth material web 33 is preferably supplied to the second corrugated cardboard production assembly 3 via at least one sixth deflection roller 38.

In order to produce, from the endless second material web 18, an endless corrugated web 39 that is provided with a corrugation, the first corrugated cardboard production assembly 1 comprises a first corrugating roller 41 which is mounted for rotation about a first axis of rotation 40, and a second corrugating roller 43 which is mounted for rotation about a second axis of rotation 42. The corrugating rollers 41, 43 together form a roller gap allowing the endless second material web 18 to be passed through in order to be provided with a corrugation, the axes of rotation 40, 42 being parallel to each other. The corrugating rollers 41, 43 together form a first corrugating assembly.

In order to join the first corrugated web 39 to the endless first material web 13 so as to form the first single-face laminated corrugated cardboard web 2, the first corrugated cardboard production assembly 1 has a first glue application assembly 44 which in turn comprises a first glue metering roller 45, a first glue tray (not shown) as well as a first glue application roller 46. The first glue application roller 46 and the first corrugating roller 41 together form a glue application gap allowing the endless first corrugated web 39 to be passed through in order to be provided with a glue layer, with the first glue application roller 46 being partly arranged, in other words immersed, in the first glue tray. The glue provided in the glue tray is then applied to tips of the corrugation of the first corrugated web 39. The first glue metering roller 45 abuts against the first glue application roller 46, thus ensuring that an even glue layer is formed on the first glue application roller 46. The first glue application roller 46 is displaceable relative to the first corrugating roller 41, thus allowing the size of the glue application gap between said rollers 46, 41 to be changed. When the size of the glue application gap is changed, the amount of glue delivered from the first glue tray to the first corrugated web 39 is changed as well.

In the first corrugated cardboard production assembly 1, the endless first material web 13 is then joined to the first corrugated web 39 provided with glue.

The first corrugated cardboard production assembly 1 has a first pressure belt device 47 for pressing the endless first material web 13 against the first corrugated web 39 provided with glue which in turn partly abuts against the first corrugating roller 41. The first pressure belt device 47 is arranged above the first corrugating roller 41. It ha a first pressure roller 49 mounted for rotation about a third axis of rotation 48, and a second pressure roller 51 mounted for rotation about a fourth axis of rotation 50 as well as an endless pressure belt 52 which is guided around the pressure rollers 49, 51.

The first corrugating roller 41 partly engages, from below, a space between the pressure rollers 49, 51, thus causing the pressure belt 52 to be deflected by the first corrugating roller 41. It presses against the endless first material web 13 which is thus pressed against the first corrugated web 39 provided with glue, said corrugated web 39 abutting against the first corrugating roller 41.

For intermediate storage and buffering, the first single-face laminated corrugated cardboard web 2 is fed to a first storage assembly 53 where it is stored in loops.

The second corrugated cardboard production assembly 3 is identical to the first corrugated cardboard production assembly 1. In order to produce from the endless fourth material web 33 a second corrugated web 54 provided with a corrugation, the second corrugated cardboard production assembly 3 comprises a third corrugating roller 56 mounted for rotation about a fifth axis of rotation 55, and a fourth corrugating roller 58 mounted for rotation about a sixth axis of rotation 57. The third corrugating roller 56 and the fourth corrugating roller 58 together form a roller gap allowing the endless fourth material web 33 to be passed through in order to be provided with a corrugation, with the fifth axis of rotation 55 and the sixth axis of rotation 57 being parallel to each other. The third corrugating roller 56 and the fourth corrugating roller 58 together form a corrugating assembly.

In order to join the endless second corrugated web 54 to the endless third material web 28 so as to form the second single-face laminated corrugated cardboard web 4, the second corrugated cardboard production assembly 3 has a second glue application assembly 59 which in turn comprises a second glue metering roller 60, a second glue tray (not shown) as well as a second glue application roller 61. The second glue application roller 61 and third corrugating roller 56 together form a glue application gap allowing the endless second corrugated web 54 to be passed through in order to be provided with a glue layer, with the second glue application roller 61 being partly arranged, in other words immersed, in the second glue tray. The glue provided in the second glue tray is then applied to tips of the corrugation of the second corrugated web 54. The second glue metering roller 60 abuts against the second glue application roller 61, thus ensuring that an even glue layer is formed on the second glue application roller 61. The second glue application roller 61 is displaceable relative to the third corrugating roller 56, thus allowing the size of the glue application gap between said rollers 61, 56 to be changed. When the size of the glue application gap is changed, the amount of glue delivered from the second glue tray to the second corrugated web 39 is changed as well.

In the second corrugated cardboard production assembly 3, the endless third material web 28 is then joined to the second corrugated web 54 provided with glue from the second glue tray.

The second corrugated cardboard production assembly 3 has a second pressure belt device 62 for pressing the endless third material web 28 against the second corrugated web 54 provided with glue which in turn partly abuts against the third corrugating roller 56. The second pressure belt device 62 is arranged above the third corrugating roller 56. It has a third pressure roller 64 mounted for rotation about a seventh axis of rotation 63, and a fourth pressure roller 66 mounted for rotation about an eighth axis of rotation 65 as well as a second pressure belt 67 which is guided around the third and fourth pressure rollers 64 and 66.

The third corrugating roller 56 partly engages, from below, a space between the third and fourth pressure rollers 64 and 66, thus causing the second pressure belt 67 to be deflected by the third corrugating roller 56. It presses against the endless third material web 28 which is thus pressed against the second corrugated web 54 provided with glue, said corrugated web 54 abutting against the third corrugating roller 56.

For intermediate storage and buffering, the second single-face laminated corrugated cardboard web 4 is fed to a second storage assembly 68 where it is stored in loops.

Downstream of the storage assemblies 53, 68, a preheating assembly 69 is arranged which comprises third, fourth and fifth preheating devices 70, 71 and 72. The third, fourth and fifth preheating devices 70, 71 and 72 are arranged one above the other. The fourth preheating device 71 is arranged between the preheating devices 70, 72.

The third preheating device 70 has a third heatable preheating roller 73 while the fourth preheating device 71 has a fourth heatable preheating roller 74. The fifth preheating device 72 has a fifth heatable preheating roller 75. The preheating rollers 73, 74, 75 are heatable independently of each other, in other words the preheating temperatures of the preheating rollers 73, 74, 75 are changeable.

The first corrugated cardboard web 2 is fed to the third preheating device 70 so as to partly abut against the third preheating roller 73 with one side. The second corrugated cardboard web 4 is fed to the fourth preheating device 72 so as to partly abut against the fourth preheating roller 74 with one side. An endless cover web 76 is fed to the fifth preheating device 72 so as to partly abut against the fifth preheating roller 75 with one side.

In order to unwind a non-endless ninth material web from a ninth material web roll 78, a fifth splicer 77 comprises a ninth unwinding unit 79 and a tenth unwinding unit 81 in order to unwind a non-endless tenth material web from a tenth material web roll 80. The non-endless ninth and tenth material webs are joined together by means of a joining and cutting unit (not shown) of the fifth splicer 77 in order to provide the endless cover web 76. Each time a non-endless ninth material web is joined to a non-endless tenth material web, a joint is produced in the endless cover web 76.

Downstream of the preheating assembly 69, a glue application assembly 82 is arranged which comprises a first glue application device 83 and a second glue application device 84 and is shown in FIG. 2. The first glue application device 83 has a first glue application roller 85 which is immersed into a first glue bath 86 so as to deliver glue from the first glue bath 86 to the preheated first corrugated cardboard web 2. The first glue application roller 85 is displaceable such that the amount to glue delivered or deliverable to the first corrugated cardboard web 2 is changeable.

The second glue application device 84 has a second glue application roller 87 which is immersed into a second glue bath 88 so as to deliver glue from the second glue bath 88 to the preheated second corrugated cardboard web 4. The second glue application roller 87 is displaceable such that the amount to glue delivered or deliverable to the second corrugated cardboard web 4 is changeable. The first glue application roller 85 and the second glue application roller 87 are displaceable independently of each other.

In the glue application assembly 82, the cover web 76 is guided over a seventh deflection roller 89. The second glue application device 84 is arranged between the first glue application device 83 and the seventh deflection roller 89.

A heating and pressing assembly 90 is arranged downstream of the glue application assembly 82. The heating and pressing assembly 90 comprises a horizontal table 91 with heating members 92. The heating temperature of the heating members 92 is changeable. The heating and pressing assembly 90 has an endless pressure belt 94 provided above the table 91, the pressure belt 94 being deflected via rollers 93. The pressure belt 94 allows the first corrugated cardboard web 2 to be sprayed with steam. A pressure gap 95 is formed between the pressure belt 94 and the table 91 through which the first corrugated cardboard web 2 provided with glue, the second corrugated cardboard web 4 provided with glue and the cover layer 76 are guided so as to be pressed together. The heating members 92 are arranged adjacent to the cover layer 76 while the pressure belt 94 is arranged adjacent to the first corrugated cardboard web 2. In the heating and pressing assembly 90, an endless corrugated cardboard web 96 is formed which comprises five layers.

Downstream of the heating and pressing assembly 90, the corrugated cardboard installation has a longitudinal cutting and corrugating assembly 97. At its inlet end, the longitudinal cutting and corrugating assembly 97 comprises two corrugating stations 98 arranged one behind the other and two longitudinal cutting stations 99 arranged one behind the other.

Each of the corrugating stations 98 is provided with corrugating tools 100 arranged one above the other such as to form a pair between which the five-layer corrugated cardboard web 96 is passed through.

Each of the longitudinal cutting stations 99 is provided with rotatably drivable knives 101 which are engageable with the five-layer corrugated cardboard web 96 for cutting said corrugated cardboard web 96 in a longitudinal direction. When immersed in the five-layer corrugated cardboard web 96, the knives 101 interact with rotatably driven brush rollers (not shown) arranged opposite to each other. By means of the longitudinal cutting stations 99, the previously undivided five-layer corrugated cardboard web 96 is dividable into a number of endless partial corrugated cardboard webs 110 which are transported in a transport direction 105 and are initially arranged next to each other.

Downstream of the longitudinal cutting and corrugating assembly 97, a short and cross-cutting assembly 102 is arranged. The short and cross-cutting assembly 102 has a casing 103 in which a roller 104 is mounted for rotation about an axis of rotation 106 extending perpendicular to the transport direction 105 of the corrugated cardboard web 96. The casing 103 of the short and cross-cutting assembly 102 is configured such that the five-layer corrugated cardboard web 96 is transportable through the short and cross-cutting assembly 102 below the rotatably driven roller 104. The roller 104 is provided with a radially outwardly extending knife 107 which extends across the entire width of the five-layer corrugated cardboard web 96 in a direction perpendicular to the transport direction 105.

In the casing 103, several support units 108 are arranged below the five-layer corrugated cardboard web 96 such as to be adjacent to each other and perpendicular to the transport direction 105. Each support unit 108 comprises a cutting support 109 also referred to as anvil which is mounted to a piston rod of a hydraulic cylinder (not shown). The piston rod is displaceable in the transport direction 105 in a casing of the hydraulic cylinder. The end of the casing of the hydraulic cylinder remote from the piston rod is mounted to the casing 103 of the short and cross-cutting assembly 102. Each cutting support 109 is movable into a first and second position by means of the associated hydraulic cylinder. In the first position, which is the cutting position, the cutting support 109 is located directly below the roller 104. The vertical distance of the roller 104 from the cutting support 109 is selected such that when the roller 104 rotates about the axis of rotation 106, the knife 107 is located just above the cutting support 109 so that there is no direct contact therewith. In the second position, which is the non-cutting position, the piston rod of the hydraulic cylinder is fully extended so that the cutting support 109 is located in front of the roller 104 when seen in the transport direction 105. The short and cross-cutting assembly 102 on the one hand allows one to reliably remove start-up waste and to change orders or formats on the other. In the event of a change of format, the short and cross-cutting assembly 102 allows connection cuts to be produced in a direction perpendicular or oblique to the transport direction 105, said connection cuts interconnecting the longitudinal cuts produced by means of the longitudinal cutting stations 99, with the result that the partial corrugated cardboard webs 110 preferably remain endless.

Downstream of the short and cross-cutting assembly 102, a switch 111 is arranged which comprises a feed table 112 for feeding the partial corrugated cardboard webs 110 and a discharge table unit 113 comprising three discharge tables 114 for discharging the partial corrugated cardboard webs 110 in three directions. Preferably, several switch members are provided to facilitate transfer of the partial corrugated cardboard webs 110 from the feed table 112 to the discharge tables 114, said switch members being pivotably arranged at the feed table 112 next to each other in a direction transverse to the transport direction 1054 so as to be pivotable relative to the discharge tables 114 into corresponding angular positions. A different number of discharge table units 113 is alternatively conceivable as well.

Downstream of the switch 111, a cross-cutting assembly 115 is provided which has three cross-cutting units 116 arranged one above the other. Each cross-cutting unit 116 comprises two rotatably drivable cross-cutting rollers 117 which are in each case arranged one above the other such as to form a pair and extend in a direction transverse to the transport direction 105. Each cross-cutting roller 117 has a radially outwardly extending cross-cutting knife 118 allowing the partial corrugated cardboard webs 110 to be cut through entirely in the transverse direction so as to produce corrugated cardboard sheets 119. The cross-cutting knives 118 of each cross-cutting unit 116 interact with each other for cross-cutting the partial corrugated cardboard webs 110 and are driven accordingly.

Downstream of each cross-cutting unit 116, a conveyor belt 120 is arranged allowing the corrugated cardboard sheets 119 thus cut to be transported to stacking and deposit units 121. Each conveyor belt 120 is associated to one stacking and deposit unit 121.

The corrugated cardboard installation further comprises a warp detection assembly 122 for detecting the warp of the partial corrugated cardboard webs 110 and of the corrugated cardboard sheets 119.

To this end, the warp detection assembly 122 has a first warp detection device 123 which is arranged upstream of the cross-cutting assembly 115 and extends transversely to the transport direction 105 across the entire width of the partial corrugated cardboard webs 110. A closer look reveals that said warp detection device 123 is arranged between the longitudinal cutting and corrugating assembly 97 and the cross-cutting assembly 115. An even closer look reveals that said warp detection device 123 is arranged between the short and cross-cutting assembly 102 and the cross-cutting assembly 115. A closer look reveals that the first warp detection device 123 is arranged between the short and cross-cutting unit 102 and the switch 111. Preferably, it is immovable at least in the transport direction 105.

The first warp detection device 123 is capable of detecting the warp of the partial corrugated cardboard webs 110. To this end, the first warp detection device 123 comprises for instance a first warp detection sensor which is arranged above or below the partial corrugated cardboard webs 110. Alternatively, two warp detection sensors are provided which are arranged opposite to each other, with the partial corrugated cardboard webs 110 then passing between said warp detection sensors.

The first warp detection device 123 is in particular capable of detecting the warp of the partial corrugated cardboard webs 110 in the transport direction 105 and/or in an upward and/or downward direction transverse thereto relative to a plane, in other words relative to their extension in a plane.

The first warp detection device 123 is in signal communication, via a first signal line 124, with an information processing device 125. Via the first signal line 124, warp information relating to the individual partial corrugated cardboard webs 110 are transmitted to the information processing device 125.

The warp detection assembly 122 further comprises a second warp detection device 126 which is arranged downstream of the cross-cutting assembly 115. A closer look reveals that said second warp detection device 126 is arranged between the cross-cutting assembly 115 and the stacking and deposit units 121.

The second warp detection device 126 in turn has three second warp detection units 127. Each conveyor belt 120 is associated to one warp detection unit 127. Each warp detection unit 127 may comprise a warp detection sensor which is arranged above or below the respective conveyor belt 120 and is preferably immovable at least in the direction of conveyance thereof. Alternatively, each warp detection unit 127 has two warp detection sensors which are arranged in pairs above and below the respective conveyor belt 120 so as to detect the warp of the corrugated cardboard sheets 119 transported thereon.

The warp detection units 127 are capable of detecting the warp of the corrugated cardboard sheets 119 in their respective transport directions and/or in an upward and/or downward direction transverse thereto relative to a plane, in other words relative to their extension in a plane.

Each warp detection unit 127 is in signal communication, via a second signal line 128, with the information processing device 125. Via said second signal lines 128, warp information relating to the corrugated cardboard sheets 119 is transmittable to the information processing device 125.

The information processing device 125 is in particular capable of changing or correcting desired values for the corrugated cardboard webs 2, 4, 96 or the corrugated cardboard webs 110, in particular the preheating temperature of the first preheating roller 21, the preheating temperature of the second preheating roller 36, the preheating temperature of the third preheating roller 73, the preheating temperature of the fourth preheating roller 74, the preheating temperature of the fifth preheating roller 75, the heating temperature of the heating members 92, the supply of steam via the pressure belt 94, the glue gap in the first corrugated cardboard production assembly 1 and/or the glue gap in the second corrugated cardboard production assembly 3.

To this end, the information processing device 125 is in signal communication, via a third signal line 129, with the first preheating assembly 20, thus allowing the preheating temperature of its preheating roller 21 to be changed according to requirements in order to influence the warp of the corrugated cardboard sheets 119.

The information processing device 125 is in signal communication, via a fourth signal line 130, with the first glue application assembly 44 of the first corrugated cardboard production assembly 1, thus allowing the glue application roller 46 thereof to be displaced according to requirements in order to change the application of glue, in particular the amount of glue applied, so as to influence the warp of the corrugated cardboard sheets 119.

The information processing device 125 is in signal communication with the second preheating assembly 35 via a fifth signal line 131, thus allowing the preheating temperature of the preheating roller 36 thereof to be changed according to requirements in order to influence the warp of the corrugated cardboard sheets 119.

The information processing device 125 is in signal communication with the second glue application assembly 59 of the second corrugated cardboard production assembly 3 via a sixth signal line 132, thus allowing the glue application roller 61 thereof to be displaced according to requirements so as to change the application of glue, in particular the amount of glue applied, to influence the warp of the corrugated cardboard sheets 119.

The information processing device 125 is further in signal communication, via a seventh signal line 133, with the third preheating device 70, the fourth preheating device 71 and the fifth preheating device 72, thus allowing the preheating temperatures of their preheating rollers 73, 74, and 75, respectively, to be changed independently of each other according to requirements in order to influence the warp of the corrugated cardboard sheets 119.

The information processing device 125 is in signal communication with the first glue application assembly 83 and the second glue application assembly 84 via an eighth signal line 134, thus allowing the position of their glue application rollers 85 and 87, respectively, to be changed in order to influence the warp of the corrugated cardboard sheets 119.

The information processing device 125 is in signal communication with the heating and pressure assembly 90 via a ninth signal line 135, thus allowing the heating temperature of its heating members 92 and/or the supply of steam via the pressure belt 94 to be changed according to requirements in order to influence the warp of the corrugated cardboard sheets 119. In order to influence the warp of the corrugated cardboard sheets 119, at least one of the corrugated cardboard sheet warp influencing assemblies 20, 35, 44, 59, 69, 82, 90 is actuated correspondingly via the respective signal line 124, 128 to 135.

When the information processing device 125 determines at the second warp detection device 126 that a warp of the corrugated cardboard sheets 119 differs from a desired warp of the corrugated cardboard sheets 119, the information processing device 125 stores the warp of the partial corrugated cardboard webs 110 and/or warp information relating thereto, said information being detected by the first warp detection device 123, as well as the warp of the corrugated cardboard sheets 119 and/or warp information relating thereto, said information being detected by the second warp detection device 126.

When the warp of the partial corrugated cardboard webs 110 is changed at the first warp detection device 123 by means of at least one of the corrugated cardboard warp influencing assemblies 20, 35, 44, 59, 69, 82, 90, the information processing device 125 interrupts a warp regulation of the corrugated cardboard sheets 119.

At the second warp detection device 126, the information processing device 125 then compares the actual warp of the corrugated cardboard sheets 119 with the desired warp of the corrugated cardboard sheets 119. The information processing device 125 continues to do so until the actual warp of the corrugated cardboard sheets 119 corresponds to the desired warp of the corrugated cardboard sheets 119.

When the first warp detection device 123 detects a change in the warp of the partial corrugated cardboard webs 110, the information processing device 125 immediately initiates a change of the warp of the corrugated cardboard sheets 119 by means of at least one of the corrugated cardboard sheet warp influencing assemblies 20, 35, 44, 59, 69, 82, 90.

The warp tendency from the first warp detection device 123 towards the second warp detection device 126 is stored in the information processing assembly 125 to reduce the regulation path to the first warp detection device 123.

It is advantageous if the information processing device 125 comprises a programmable logic controller 136 for controlling the heating and preheating temperatures as well as the application of glue.

It is advantageous if the information processing device 125 comprises a user interface. The user interface allows a user to manipulate the regulation processes in the corrugated cardboard installation, in other words the warp of the corrugated cardboard sheets 119, to be influenced.

What is claimed is:

1. A corrugated cardboard installation for the production of corrugated cardboard sheets, comprising
a. a first material supply device for dispensing a first material web,
b. a second material supply device for dispensing a second material web,
c. a first corrugated cardboard production device for producing a first corrugated cardboard web laminated on at least one side from at least the first material web and the second material web,
d. a cross-cutting for producing corrugated cardboard sheets from at least the first corrugated cardboard laminated on at least one side,
e. a warp detection assembly for detecting a warp of at least one of the group comprising the corrugated cardboard sheets and partial corrugated cardboard webs produced at least from the first corrugated cardboard web laminated on at least one side,
f. an information processing device which receives from the warp detection assembly warp information relating to at least one of the group comprising the corrugated cardboard sheets and the partial corrugated cardboard webs, and
g. at least one corrugated cardboard sheet warp influencing assembly for influencing the warp of the corrugated cardboard sheets, wherein the at least one corrugated cardboard sheet warp influencing assembly is actuable depending on the signals received from the information processing device.

2. A corrugated cardboard installation according to claim 1, wherein a first corrugated cardboard sheet warp influencing assembly for influencing the warp of the corrugated cardboard sheets is arranged between the first material supply device and the first corrugated cardboard production assembly, said first corrugated cardboard sheet warp influencing assembly being associated to the first material web.

3. A corrugated cardboard installation according to claim 2, wherein the first corrugated cardboard sheet warp influencing assembly is configured as a first preheating assembly for preheating the first material web on one side, and the information processing device changes a preheating temperature of the first preheating assembly for influencing the warp of the corrugated cardboard sheets.

4. A corrugated cardboard installation according to claim 1, wherein the first corrugated cardboard production assembly comprises a second corrugated cardboard sheet warp influencing assembly for influencing the warp of the corrugated cardboard sheets, said second corrugated cardboard sheet warp influencing assembly being associated to at least one of the group comprising the first material web and the second material web.

5. A corrugated cardboard installation according to claim 4, wherein the second corrugated cardboard sheet warp influencing assembly is configured as a glue application assembly for applying glue to one side of at least one of the group comprising the first material web and the second material web, and the information processing device changes an application of glue to at least one of the group comprising the first material web and the second material web by means of the glue application assembly in order to influence the warp of the corrugated cardboard sheets.

6. A corrugated cardboard installation according to claim 1, comprising
a. a third material supply device for dispensing a third material web,
b. a fourth material supply device for dispensing a fourth material web, and
c. a second corrugated cardboard production assembly for producing a second corrugated cardboard web laminated on at least one side from at least the third material web and the fourth material web.

7. A corrugated cardboard installation according to claim 6, wherein a third corrugated cardboard sheet warp influencing assembly for influencing the warp of the corrugated cardboard sheets is arranged between the third material supply device and the second corrugated cardboard production assembly, said third corrugated cardboard sheet warp influencing assembly being associated to the third material web.

8. A corrugated cardboard installation according to claim 7, wherein the third corrugated cardboard sheet warp influencing assembly is configured as a second preheating assembly for preheating the third material web on one side, and the information processing device changes a preheating temperature of the second preheating assembly for influencing the warp of the corrugated cardboard sheets.

9. A corrugated cardboard installation according to claim 6, wherein the second corrugated cardboard production assembly comprises a fourth corrugated cardboard sheet warp influencing assembly for influencing the warp of the corrugated cardboard sheets, said fourth corrugated cardboard sheet warp influencing assembly being associated to at least one of the group comprising the third material web and the fourth material web.

10. A corrugated cardboard installation according to claim 9, wherein the fourth corrugated cardboard sheet warp influencing assembly is configured as a glue application assembly for applying glue to one side of at least one of the group comprising the third material web and the fourth material web, and the information processing device changes an application of glue to at least one of the group comprising the third material web and the fourth material web by means of the glue application assembly in order to influence the warp of the corrugated cardboard sheets.

11. A corrugated cardboard installation according to claim 6, comprising a preheating assembly for preheating a respective side of at least the first corrugated cardboard web and the second corrugated cardboard web from in each case one side, wherein the preheating assembly forms a fifth corrugated cardboard sheet warp influencing assembly for influencing the warp of the corrugated cardboard sheets, and the information processing changes a preheating temperature of the preheating assembly near at least one of the group comprising the first corrugated cardboard web and the second corrugated cardboard web in order to influence the warp of the corrugated cardboard sheets.

12. A corrugated cardboard installation according to claim 6, comprising a glue application unit for applying glue to a respective side of the first corrugated cardboard web and the second corrugated cardboard web, wherein the glue application unit forms a sixth corrugated cardboard sheet warp influencing assembly for influencing the warp of the corrugated cardboard sheets, and the information processing device changes an application of glue to at least one of the group comprising the first corrugated cardboard web and the second corrugated cardboard web by means of the glue application unit in order to influence the warp of the corrugated cardboard sheets.

13. A corrugated cardboard installation according to claim 6, comprising a heating and pressure assembly for pressing together the first corrugated cardboard web, the second corrugated cardboard web and a cover web and for heating at least one of them on one side, wherein the heating and pressure assembly forms a seventh corrugated cardboard sheet warp influencing assembly for influencing the warp of the corrugated cardboard sheets, and the information processing device changes at least one of the group comprising a heating temperature of the heating and pressure assembly and a supply of moisture to at least one of the outer webs by means of the heating and pressure assembly in order to influence the warp of the corrugated cardboard sheets.

14. A corrugated cardboard installation according to claim 1, wherein the warp detection assembly comprises a first warp detection device which is arranged upstream of the cross-cutting assembly.

15. A corrugated cardboard installation according to claim 14, wherein the first warp detection device is arranged between the cross-cutting assembly and a longitudinal cutting and corrugating assembly for producing the partial corrugated cardboard webs, wherein the longitudinal cutting and corrugating assembly is arranged upstream of the cross-cutting assembly.

16. A corrugated cardboard installation according to claim 1, wherein the warp detection assembly comprises a second warp detection device which is arranged downstream of the cross-cutting assembly for detecting the warp of the corrugated cardboard sheets.

17. A corrugated cardboard installation according to claim 14, wherein the information processing device stores a warp of the partial corrugated cardboard webs detected by the first warp detection device and a warp of the corrugated cardboard sheets detected by the second warp detection device at least temporarily if the information processing device determines at the second warp detection device a deviation of the warp of the corrugated cardboard sheets from a desired warp of the corrugated cardboard sheets.

18. A corrugated cardboard installation according to claim 14, wherein the information processing device interrupts a regulation of the warp of the corrugated cardboard sheets when the warp of the partial corrugated cardboard webs is changed at the first warp detection device by means of at least one of the corrugated cardboard sheet warp influencing assemblies, and the information processing device then compares at the second warp detection device the actual warp of the corrugated cardboard sheets with the desired warp of the corrugated cardboard sheets, wherein the information processing device continues to do so until the actual warp of the corrugated cardboard corresponds to the desired warp of the corrugated cardboard sheets.

19. A corrugated cardboard installation according to claim 14, wherein when a change in the warp of the partial corrugated cardboard webs is detected at the first warp detection device, the information processing device immediately initiates a change of the warp of the corrugated cardboard sheets by means of at least one of the corrugated cardboard sheet warp influencing assemblies.

20. A corrugated cardboard installation according to claim 19, wherein the information processing device stores the warp tendency from the first warp detection device towards the second warp detection device to reduce the regulation path to the first warp detection device.

21. A corrugated cardboard installation according to claim 1, wherein the information processing device actuates at least one of the corrugated cardboard sheet warp influencing assemblies in such a way that the corrugated cardboard sheets are each plane.

22. A corrugated cardboard installation according to claim 21, wherein the information processing device actuates at least one of the corrugated cardboard sheet warp influencing assemblies such that the corrugated cardboard sheets each have a desired warp.

23. A method for the production of corrugated cardboard sheets, comprising the steps of
dispensing a first material web from a first material supply device,
dispensing a second material web from a second material supply device,
producing, by means of a first corrugated cardboard production assembly, a first corrugated cardboard web laminated on at least one side from at least the first material web and the second material web,
producing corrugated cardboard sheets from at least the first corrugated cardboard web laminated on at least one side by means of a cross-cutting assembly,
detecting a warp of at least one of the group comprising the corrugated cardboard sheets and partial corrugated cardboard webs from at least the first corrugated cardboard web laminated on at least one side by means of a warp detection assembly,
transmitting warp information relating to at least one of the group comprising the corrugated cardboard sheets and the partial corrugated cardboard webs from the warp detection assembly to an information processing device, and
influencing the warp of the corrugated cardboard sheets depending on signals received from the information processing device by means of at least one actuable corrugated cardboard sheet warp influencing assembly.
